(19) United States
(12) Patent Application Publication
(10) Pub. No.: US 2017/0291539 A1
(43) Pub. Date: Oct. 12, 2017

(54) SYSTEMS AND METHODS FOR DETECTING OBJECTS WITHIN A VEHICLE

(71) Applicant: GENERAL MOTORS LLC, Detroit, MI (US)

(72) Inventor: CARTER T. AVERY, ROCHESTER HILLS, MI (US)

(73) Assignee: GENERAL MOTORS LLC, Detroit, MI (US)

(21) Appl. No.: 15/092,807

(22) Filed: Apr. 7, 2016

(51) Int. Cl. B60Q 5/00; G01S 15/04; G01S 17/02; B60N 2/00; G05D 1/00; G01C 21/34

(52) U.S. Cl. CPC B60Q 5/005; G05D 1/0088; G01C 21/34; G01S 17/026; B60N 2/002; G01S 15/04

(57) ABSTRACT

Methods and systems are provided for detecting objects within a vehicle. A sensor monitors an interior of the vehicle and generates sensor data. A detection module detects objects in the interior of the vehicle based on the sensor data. An action module takes an action based on the objects detected in the interior.

### TECHNICAL FIELD

The technical field generally relates to object detection systems, and more particularly relates to methods and systems for detecting extraneous objects in a vehicle using a sensor.

### BACKGROUND

Vehicle rental, vehicle sharing, ride sharing, and the development of autonomous vehicles allows for individuals to share or rent time using a vehicle without vehicle ownership. This in turn allows for rental companies to maximize vehicle uptime and for users to enjoy the benefits of vehicle transportation without ownership. Currently, vehicle renting and sharing companies have staffed rental centers where cars are turned in, inspected, cleaned, and made ready for the next user. However, this business model is shifting towards one where vehicles may be parked in a lot and rapidly turned around to another user without being inspected by a human. This is more convenient for users as they can simply walk up and use a vehicle while also being more cost effective for companies by reducing overhead.

However, as with any publically used space or item, users may inadvertently leave objects in the vehicle, create a mess for the next user, or damage a portion of the vehicle. Likewise, an owner or operating company needs ways to ensure that the interior of the vehicle will be in good condition for the next user, alert the previous user of any items left behind, and identify any vehicles in need of cleaning or repair.

Accordingly, it is desirable to provide systems and methods for detecting objects in a vehicle. It is additionally desirable to compare a state of the vehicle interior before and after use to allow for the identification of any changes to the vehicle interior. Furthermore, other desirable features and characteristics of the present invention will become apparent from the subsequent detailed description and the appended claims, taken in conjunction with the accompanying drawings and the foregoing technical field and background.

### SUMMARY

Systems and methods are provided for detecting objects within a vehicle. In one non-limiting example, a system for detecting objects within a vehicle includes, but is not limited to, a sensor that is configured to monitor an interior of the vehicle and generate sensor data. The system further includes, but is not limited to, a detection module that is configured to detect objects in the interior of the vehicle based on the sensor data. The system further includes, but is not limited to, an action module that is configured to take an action based on the objects detected in the interior.

In another non-limiting example, a system for detecting objects within a vehicle includes, but is not limited to, a remote server. The system further includes, but is not limited to, a sensor that is configured to monitor an interior of the vehicle and generate sensor data. The system further includes, but is not limited to, a telematics control unit that is configured to transmit the sensor data to the server and take an action. The remote server identifies objects in the interior of the vehicle based on the sensor data and transmits an action instruction to the telematics control unit based on the objects identified in the interior.

In another non-limiting example, a method is provided for detecting objects within a vehicle. The method includes, but is not limited to, capturing sensor data of an interior of the vehicle with a sensor. The method further includes, but is not limited to, detecting objects in the interior of the vehicle based on the captured sensor data. The method further includes, but is not limited to, taking an action based on the objects detected in the vehicle.

### DESCRIPTION OF THE DRAWINGS

The disclosed examples will hereinafter be described in conjunction with the following drawing figures, wherein like numerals denote like elements, and wherein:

FIG. 1 is a diagram illustrating a non-limiting example of a communication system;

FIG. 2 is diagram illustrating a non-limiting example of a system for detecting objects within a vehicle according to an embodiment;

FIG. 3 is a diagram illustrating a non-limiting example of a system for detecting objects within a vehicle according to another embodiment; and

FIG. 4 is a flowchart illustrating a non-limiting example of a method for detecting objects within a vehicle.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

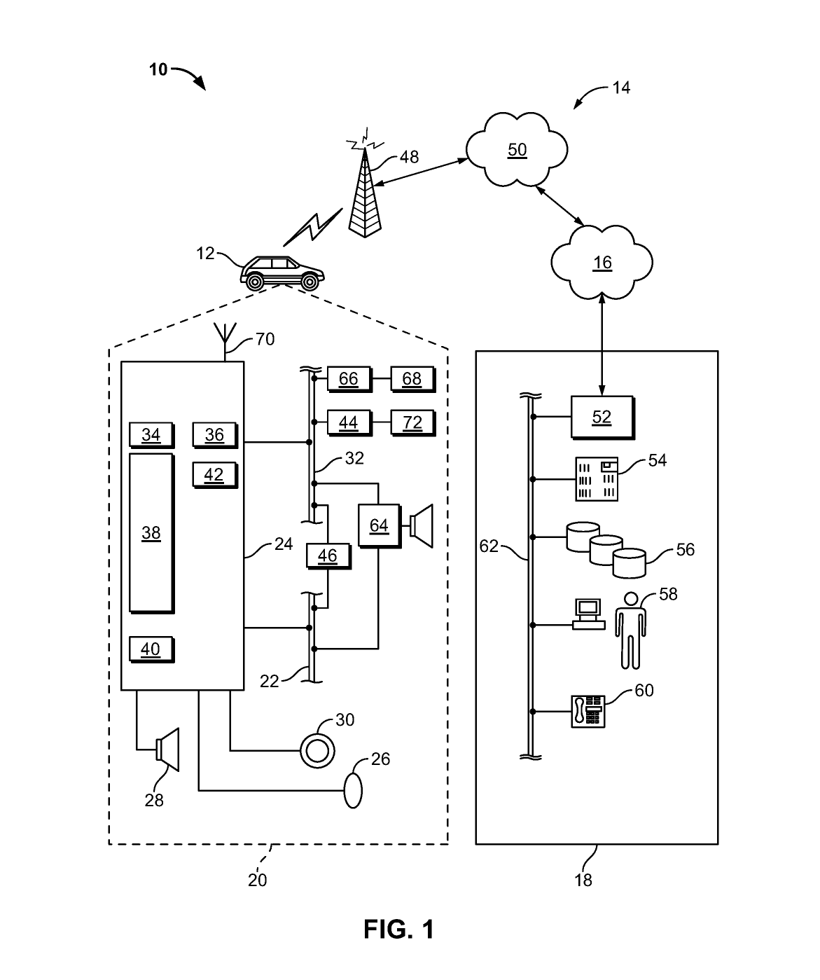

With reference to FIG. 1, there is shown a non-limiting example of a communication system 10 that may be used together with examples of the apparatus/system disclosed herein or to implement examples of the methods disclosed herein. Communication system 10 generally includes a vehicle 12, a wireless carrier system 14, a land network 16 and a call center 18. It should be appreciated that the overall architecture, setup and operation, as well as the individual components of the illustrated system are merely exemplary and that differently configured communication systems may also be utilized to implement the examples of the method disclosed herein. Thus, the following paragraphs, which provide a brief overview of the illustrated communication system 10, are not intended to be limiting.

Vehicle 12 may be any type of mobile vehicle such as a motorcycle, car, truck, recreational vehicle (RV), boat, plane, etc., and is equipped with suitable hardware and software that enables it to communicate over communication system 10. Some of the vehicle hardware 20 is shown generally in FIG. 1 including a telematics unit 24, a microphone 26, a speaker 28, and buttons and/or controls 30 connected to the telematics unit 24. Operatively coupled to the telematics unit 24 is a network connection or vehicle bus 32. Examples of suitable network connections include a controller area network (CAN), a media oriented system transfer (MOST), a local interconnection network (LIN), an Ethernet, and other appropriate connections such as those that conform with known ISO (International Organization for Standardization), SAE (Society of Automotive Engineers), and/or IEEE (Institute of Electrical and Electronics Engineers) standards and specifications, to name a few.

The telematics unit 24 is an onboard device that provides a variety of services through its communication with the call center 18, and generally includes an electronic processing device 38, one or more types of electronic memory 40, a cellular chipset/component 34, a wireless modem 36, a dual mode antenna 70, and a navigation unit containing a GNSS chipset/component 42. In one example, the wireless modem 36 includes a computer program and/or set of software routines adapted to be executed within electronic processing device 38.

The telematics unit 24 may provide various services including: turn-by-turn directions and other navigation-related services provided in conjunction with the GNSS chipset/component 42; airbag deployment notification and other emergency or roadside assistance-related services provided in connection with various crash and/or collision sensor interface modules 66 and collision sensors 68 located throughout the vehicle; and/or infotainment-related services where music, internet web pages, movies, television programs, videogames, and/or other content are downloaded by an infotainment center 46 operatively connected to the telematics unit 24 via vehicle bus 32 and audio bus 22. In one example, downloaded content is stored for current or later playback. The above-listed services are by no means an exhaustive list of all the capabilities of telematics unit 24, but are simply an illustration of some of the services that the telematics unit may be capable of offering. It is anticipated that telematics unit 24 may include a number of additional components in addition to and/or different components from those listed above.

Vehicle communications may use radio transmissions to establish a voice channel with wireless carrier system 14 so that both voice and data transmissions can be sent and received over the voice channel. Vehicle communications are enabled via the cellular chipset/component 34 for voice communications and the wireless modem 36 for data transmission. Any suitable encoding or modulation technique may be used with the present examples, including digital transmission technologies, such as TDMA (time division multiple access), CDMA (code division multiple access), W-CDMA (wideband CDMA), FDMA (frequency division multiple access), OFDMA (orthogonal frequency division multiple access), etc.

Dual mode antenna 70 services the GNSS chipset/component 42 and the cellular chipset/component 34.

Microphone 26 provides the driver or other vehicle occupant with a means for inputting verbal or other auditory commands, and can be equipped with an embedded voice processing unit utilizing a human/machine interface (HMI) technology known in the art. Conversely, speaker 28 provides audible output to the vehicle occupants and can be either a stand-alone speaker specifically dedicated for use with the telematics unit 24 or can be part of a vehicle audio component 64. In either event, microphone 26 and speaker 28 enable vehicle hardware 20 and call center 18 to communicate with the occupants through audible speech. The vehicle hardware also includes one or more buttons and/or controls 30 for enabling a vehicle occupant to activate or engage one or more of the vehicle hardware components 20. For example, one of the buttons and/or controls 30 can be an electronic pushbutton used to initiate voice communication with call center 18 (whether it be a human such as advisor 58 or an automated call response system). In another example, one of the buttons and/or controls 30 can be used to initiate emergency services.

The audio component 64 is operatively connected to the vehicle bus 32 and the audio bus 22. The audio component 64 receives analog information, rendering it as sound, via the audio bus 22. Digital information is received via the vehicle bus 32. The audio component 64 provides amplitude modulated (AM) and frequency modulated (FM) radio, compact disc (CD), digital video disc (DVD), and multimedia functionality independent of the infotainment center 46. Audio component 64 may contain a speaker system, or may utilize speaker 28 via arbitration on vehicle bus 32 and/or audio bus 22.

The vehicle crash and/or collision detection sensor interface 66 is operatively connected to the vehicle bus 32. The collision sensors 68 provide information to the telematics unit via the crash and/or collision detection sensor interface 66 regarding the severity of a vehicle collision, such as the angle of impact and the amount of force sustained.

Vehicle sensors 72, connected to various sensor interface modules 44 are operatively connected to the vehicle bus 32. Example vehicle sensors include but are not limited to gyroscopes, accelerometers, magnetometers, emission detection, and/or control sensors, and the like. Example sensor interface modules 44 include powertrain control, climate control, and body control, to name but a few.

Wireless carrier system 14 may be a cellular telephone system or any other suitable wireless system that transmits signals between the vehicle hardware 20 and land network 16. According to an example, wireless carrier system 14 includes one or more cell towers 48

Land network 16 can be a conventional land-based telecommunications network that is connected to one or more landline telephones, and that connects wireless carrier system 14 to call center 18. For example, land network 16 can include a public switched telephone network (PSTN) and/or an Internet protocol (IP) network, as is appreciated by those skilled in the art. Of course, one or more segments of the land network 16 can be implemented in the form of a standard wired network, a fiber or other optical network, a cable network, other wireless networks such as wireless local networks (WLANs) or networks providing broadband wireless access (BWA), or any combination thereof.

Call center 18 is designed to provide the vehicle hardware 20 with a number of different system back-end functions and, according to the example shown here, generally includes one or more switches 52, servers 54, databases 56, advisors 58, as well as a variety of other telecommunication/computer equipment 60. These various call center components are suitably coupled to one another via a network connection or bus 62, such as the one previously described in connection with the vehicle hardware 20. Switch 52, which can be a private branch exchange (PBX) switch, routes incoming signals so that voice transmissions are usually sent to either advisor 58 or an automated response system, and data transmissions are passed on to a modem or other piece of telecommunication/computer equipment 60 for demodulation and further signal processing. The modem or other telecommunication/computer equipment 60 may include an encoder, as previously explained, and can be connected to various devices such as a server 54 and database 56. For example, database 56 could be designed to store subscriber profile records, subscriber behavioral patterns, or any other pertinent subscriber information. Although the illustrated example has been described as it would be used in conjunction with a call center 18 that is manned, it will be appreciated that the call center 18 can be any central or remote facility, manned or unmanned, mobile or fixed, to or from which it is desirable to exchange voice and data.

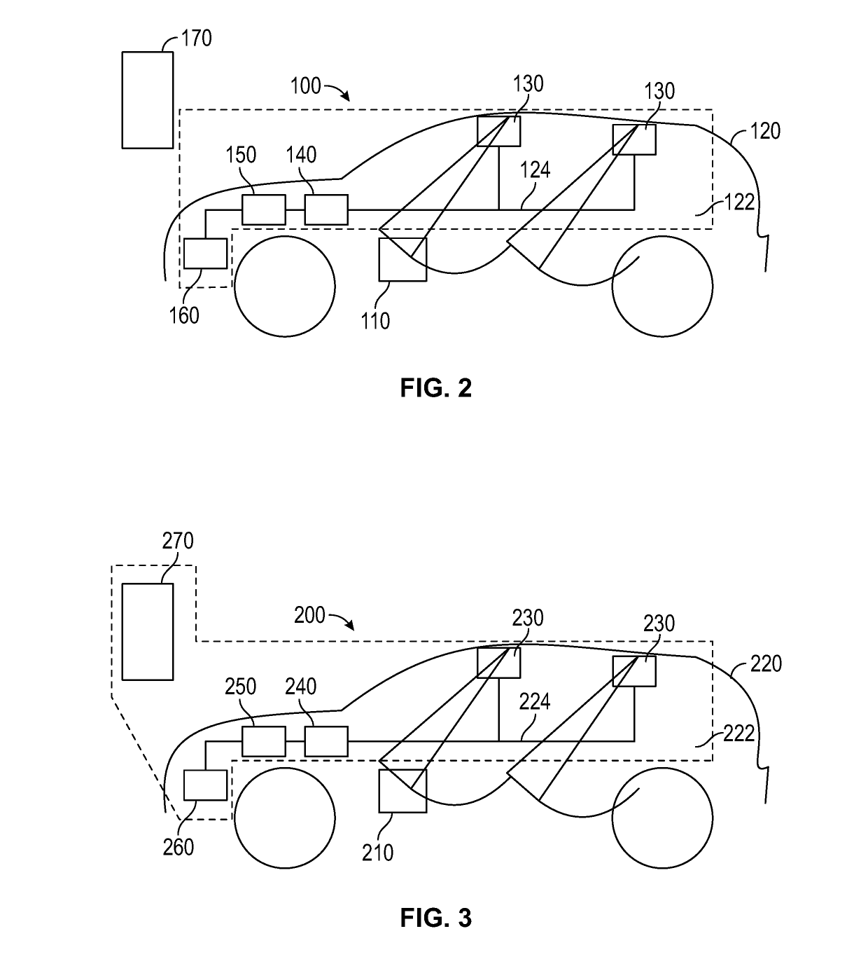

With reference to FIG. 2, there is shown a non-limiting example of a system 100 for detecting objects 110 in a vehicle 120. It should be appreciated that the overall architecture, setup and operation, as well as the individual components of the illustrated system 100 are merely exemplary and that differently configured systems may also be utilized to implement the examples of the system 100 disclosed herein. Thus, the following paragraphs, which provide a brief overview of the illustrated system 100, are not intended to be limiting.

The system 100 for detecting objects 110 within a vehicle 120 generally includes a sensor 130, and a detection module 140, and an action module 150. The term “module,” as used herein, generally refers to an electronic component, as is known to those skilled in the art, and is not intended to be limiting. The sensor 130 is configured to monitor an interior 122 of the vehicle 120 and generate sensor data. The detection module 140 is configured to detect objects 110 in the interior 122 of the vehicle based on the sensor data generated by the sensor 130. The action module 150 is configured to take an action based on the objects 110 detected in the interior 122.

Vehicle 120 may be any type of mobile vehicle such as a car, truck, recreational vehicle (RV), boat, plane, etc., and is equipped with suitable hardware and software that enables it to communicate over the system 100. In a non-limiting embodiment of the system 100, the sensor 130, detection module 140, and action module 150 are onboard the vehicle 120 and operatively coupled to a vehicle bus 124. Examples of suitable vehicle busses 124 include a controller area network (CAN), a media oriented system transfer (MOST), a local interconnection network (LIN), an Ethernet, and other appropriate connections such as those that conform with known ISO (International Organization for Standardization), SAE (Society of Automotive Engineers), and/or IEEE (Institute of Electrical and Electronics Engineers) standards and specifications, to name a few.

The sensor 130 is configured to monitor the interior 122 of the vehicle 120 and generate sensor data. In a non-limiting embodiment, the sensor 130 includes at least one of an optical sensor, an ultrasonic sensor, a laser sensor, a weight sensor, or a combination thereof. One skilled in the art will appreciate that while only two sensors 130 are shown in the embodiment of FIG. 2, this does not limit the understanding of the system 100 to only using two sensors 130. Additional combinations of sensors 130 may be used in the system 100 to provide greater coverage of the interior 122 of the vehicle 120. Likewise, fewer sensors 130 may be used in the system 100 according to design parameters specific to the vehicle 120 in which the system 100 is implemented.

In a non-limiting embodiment, the sensor data generated by the sensor 130 is electronically communicated over the bus 124. For example, the sensor data may be an image or a plurality of images of the interior 122 captured by an optical sensor. One skilled in the art will appreciate that the sensor data generated by the sensor 130 will be particular to the type of sensor 130 implemented in the system 100 and should not limit the understanding.

The detection module 140 is configured to detect objects 110 in the interior 122 of the vehicle 120 based on the sensor data. While the detection module 140 is depicted as a separate component in the system 100 of FIG. 2, one skilled in the art will appreciate that the detection module 140 may be incorporated into the sensor 130 itself or alongside another vehicle system such as a vehicle control module without departing from the spirit of the system 100. The detection module 140 uses the sensor data generated by the sensor 130 to detect objects 110 in the vehicle 120.

In a non-limiting example, the detection module 140 uses images of the interior 122 to detect objects 110. An object 110 such as a wallet, purse, mobile device, or other personal effect left by a user of the vehicle 120 may be identified by the detection module 140 using the sensor data. One skilled in the art will appreciate that the manner in which an object 110 is detected by the detection module 140 depends on the type of sensor 130 used in the system 100. Many methods for identifying features, outliers, inconsistencies, etc., in various forms of sensor data are known and are contemplated by the present disclosure. For example, the detection module 140 may use digital feature matching to identify an object 110 that stands out from its surroundings, such as a wallet left on a seat or a cell phone left in a cup holder.

In a non-limiting embodiment, the detection module 140 is configured to detect a change in the interior 122 of the vehicle 120. In addition to identifying objects 110 left behind by a user, the system 100 may additionally identify changes in the interior 122 such as interior damage, a stain, or other differences. In a non-limiting embodiment, the detection module 140 compares a steady state interior of the vehicle 120 with a present state interior of the vehicle 120. For example, the steady state interior of the vehicle 120 is an image of the interior 122 before a user begins using the vehicle 120 while the present state interior of the vehicle 120 is an image of the interior 122 immediately after the user stops using the vehicle 120. In this way, the detection module 140 can detect ways in which the user changes the interior 122 of the vehicle 120. While a comparison of images was used in the non-limiting example, one skilled in the art will appreciate that other comparisons with before and after data obtained from different types of sensors, as detailed above, is contemplated by the present disclosure.

The action module 150 is configured to take an action based on the objects 110 detected in the interior 122. While the action module 150 is depicted as a separate component in the system 100 of FIG. 2, one skilled in the art will appreciate that the action module 150 may be incorporated into the sensor 130, the detection module 140, or alongside another vehicle system such as a vehicle control module without departing from the teachings of the present disclosure. The action module 150 takes an action based on the objects 110 detected by the detection module 140.

In a non-limiting embodiment, the action taken by the action module 150 includes at least one of a user notification, a horn action, a light action, an owner notification, a route action, or a combination thereof. In a non-limiting example, the system 100 detects that a user has left a wallet in the interior 122 of the vehicle 120 and the action module 150 takes an action. The system 100 may send a notification to the user's mobile device, honk the horn of vehicle 120, flash the lights of vehicle 120, or otherwise attempt to alert the user.

In a non-limiting embodiment, the system 100 transmits the user notification to the user's mobile device is via Bluetooth protocol, a text message, a multimedia message, a near field communication, or a combination thereof. One skilled in the art will appreciate that the system 100 will accordingly be configured with a transceiver or the like to allow for the user notification to be communicated via the chosen protocol. In this way, the system 100 brings attention to the user before the user leaves the vicinity of the vehicle 120 or another user uses the vehicle 120. Accordingly, the action module 150 is in communication with vehicle systems over the bus 124 in order to take the action.

In a non-limiting embodiment, the action module 150 notifies the vehicle owner of the detected object 110. In the event that the system 100 was unable to alert the user using the notifications detailed above, notifying the vehicle owner provides yet another way of communicating that an object 110 was left in the vehicle 120.

In a non-limiting embodiment, the action includes a route action to alter a route of the vehicle 120. In a non-limiting example, the route action allows the vehicle 120 to be routed to a location to drop off objects 110 left behind in the vehicle 120 or to receive cleaning based on a change in the interior 122, as detailed above. In a non-limiting embodiment, the vehicle 120 is an autonomous vehicle and the route action allows the vehicle 120 to be directed to autonomously proceed to the location.

In a non-limiting embodiment, the system 100 further includes a telematics control unit 160 configured to report detected objects 110 to a remote server 170. The term “server,” as used herein, generally refers to electronic component, as is known to those skilled in the art, such as a computer program or a machine that waits for requests from other machines or software (clients) and responds to them. As detailed above, the telematics control unit 160 is in communication with various vehicle systems over the bus 124, such as the sensor 130, detection module, 140, and action module 150. When an object is detected by the system 100, the telematics control unit 160 reports the object 110 to the remote server 170. Once the object 110 has been reported to the remote server 170, an email or other form of electronic communication may be dispatched by the remote server 170 to further notify the user or the owner.

In a non-limiting embodiment, the telematics control unit 160 is configured to adjust a route of the vehicle 120 based on the action from the action module 150. For example, when the action module 150 takes an action to route the vehicle 120 to a location to be serviced or cleaned, the telematics control unit 160 interfaces with an onboard navigation system (not shown) or navigation from the remote server 170 to route the vehicle 120 to the location. In this way, the telematics control unit 160 may be used to improve the routing of the vehicle 120 when a routing action is taken.

In a non-limiting embodiment, the telematics control unit 160 is configured to transmit the user notification to the user's mobile device is via Bluetooth protocol, a text message, a multimedia message, a near field communication, or a combination thereof. One skilled in the art will appreciate that the telematics control unit 160 will accordingly be configured with a transceiver or the like to allow for the user notification to be communicated via the chosen protocol. In this way, the telematics control unit 160 brings attention to the user before the user leaves the vicinity of the vehicle 120 or another user uses the vehicle 120.

With reference now to FIG. 3 and with continued reference to FIG. 2, there is shown a non-limiting example of a system 200 for detecting objects 210 in a vehicle 220. It should be appreciated that the overall architecture, setup and operation, as well as the individual components of the illustrated system 200 are merely exemplary and that differently configured systems may also be utilized to implement the examples of the system 200 disclosed herein. Thus, the following paragraphs, which provide a brief overview of the illustrated system 200, are not intended to be limiting. As similar components are used in the system 200 relative to the system 100, similar reference numerals will be used and the description of system 200 will focus on the differences relative to the system 100.

The system 200 for detecting objects 210 in a vehicle 220 generally includes a sensor 230, a telematics control unit 260, and a remote server 270. The sensor 230 is configured to monitor an interior 222 of the vehicle 220 and generate sensor data. The telematics control unit 260 is configured to transmit the sensor data to the remote server 270 and take an action. The remote server 270 is configured to identify objects 210 in the interior 222 of the vehicle 220 based on the sensor data and transmit an action instruction to the telematics control unit based on the objects 210 identified in the interior 222.

Relative to system 100, in system 200 the sensor data is transmitted to the remote server 270 and the remote server 270 identifies the objects 210 and provides instructions to the telematics control unit 260. In this way, the system 200 provides an embodiment in which the identification of objects 210 and selection of an action are handled by the remote server 270.

Vehicle 220 may be any type of mobile vehicle such as a car, truck, recreational vehicle (RV), boat, plane, etc., and is equipped with suitable hardware and software that enables it to communicate over the system 200. In a non-limiting embodiment of the system 200, the sensor 130 and telematics control unit 160 are onboard the vehicle 220 and operatively coupled to a vehicle bus 224. Examples of suitable vehicle busses 224 include a controller area network (CAN), a media oriented system transfer (MOST), a local interconnection network (LIN), an Ethernet, and other appropriate connections such as those that conform with known ISO (International Organization for Standardization), SAE (Society of Automotive Engineers), and/or IEEE (Institute of Electrical and Electronics Engineers) standards and specifications, to name a few.

The sensor 230 is configured to monitor the interior 222 of the vehicle 220 and generate sensor data. In a non-limiting embodiment, the sensor 230 includes at least one of an optical sensor, an ultrasonic sensor, a laser sensor, a weight sensor, or a combination thereof. One skilled in the art will appreciate that while only two sensors 230 are shown in the embodiment of FIG. 3, this does not limit the understanding of the system 200 to only using two sensors 230. Additional combinations of sensors 230 may be used in the system 200 to provide greater coverage of the interior 222 of the vehicle 220. Likewise, fewer sensors 230 may be used in the system 200 according to design parameters specific to the vehicle 220 in which the system 200 is implemented.

In a non-limiting embodiment, the sensor data generated by the sensor 230 is electronically communicated over the bus 224 to the telematics control unit 260. For example, the sensor data may be an image or a plurality of images of the interior 222 captured by an optical sensor. One skilled in the art will appreciate that the sensor data generated by the sensor 230 will be particular to the type of sensor 230 implemented in the system 200 and should not limit the understanding.

The telematics control unit 260 is configured to transmit the sensor data to the remote server 270 and take an action. As detailed above, the telematics control unit 260 is in communication with various vehicle systems over the bus 224, such as the sensor 230. In the embodiment of the system 200, the telematics control unit 260 transmits the sensor data to the remote server 270. The telematics control unit 260 is further configured to take an action, similar to the action module 150 from system 100.

The remote server 270 is configured to detect objects 210 in the interior 222 of the vehicle 220 based on the sensor data. In a non-limiting example, the remote server 270 uses images of the interior 222 to detect objects 210. An object 210 such as a wallet, purse, mobile device, or other personal effect left by a user of the vehicle 220 may be identified by the remote server 270 using the sensor data. One skilled in the art will appreciate that the manner in which an object 210 is detected by the remote server 270 depends on the type of sensor 230 used in the system 200. Many methods for identifying features, outliers, inconsistencies, etc., in various forms of sensor data are known and are contemplated by the present disclosure. For example, the remote server 270 may use digital feature matching to identify an object 210 that stands out from its surroundings, such as a wallet left on a seat or a cell phone left in a cup holder.

In a non-limiting embodiment, the remote server 270 is configured to detect a change in the interior 222 of the vehicle 220. In addition to identifying objects 210 left behind by a user, the system 200 may additionally identify changes in the interior 222 such as interior damage, a stain, or other differences. In a non-limiting embodiment, the remote server 270 compares a steady state interior of the vehicle 220 with a present state interior of the vehicle 220. For example, the steady state interior of the vehicle 220 is an image of the interior 222 before a user begins using the vehicle 220 while the present state interior of the vehicle 220 is an image of the interior 222 immediately after the user stops using the vehicle 220. In this way, the remote server 270 can detect ways in which the user changes the interior 222 of the vehicle 220. While a comparison of images was used in the non-limiting example, one skilled in the art will appreciate that other comparisons with before and after data obtained from different types of sensors, as detailed above, is contemplated by the present disclosure.

The remote server 270 transmits an action instruction to the telematics control unit 260 based on the objects 210 identified in the interior 222 of the vehicle 220. In a non-limiting embodiment, the action induced by the action instruction includes at least one of a user notification, a horn action, a light action, an owner notification, a route action, or a combination thereof. In a non-limiting example, the system 200 detects that a user has left a wallet in the interior 222 of the vehicle 220 and the telematics control unit 260 receives an action instruction to take an action. The system 200 may send a notification to the user's mobile device, honk the vehicle's 220 horn, flash the vehicle's 220 lights, or otherwise attempt to alert the user.

In a non-limiting embodiment, the system 200 transmits the user notification to the user's mobile device is via Bluetooth protocol, a text message, a multimedia message, a near field communication, or a combination thereof. One skilled in the art will appreciate that the system 200 will accordingly be configured with a transceiver or the like to allow for the user notification to be communicated via the chosen protocol.

In a non-limiting embodiment, the telematics control unit 260 is configured to transmit the user notification to the user's mobile device is via Bluetooth protocol, a text message, a multimedia message, a near field communication, or a combination thereof. One skilled in the art will appreciate that the telematics control unit 160 will accordingly be configured with a transceiver or the like to allow for the user notification to be communicated via the chosen protocol. In this way, the system 200 brings attention to the user before the user leaves the vicinity of the vehicle 220 or another user uses the vehicle 220. Accordingly, the telematics control unit 260 is in communication with vehicle systems over the bus 224 in order to take the action.

In a non-limiting embodiment, the system 200 notifies the vehicle owner of the detected object 210. In the event that the system 200 was unable to alert the user using the notifications detailed above, notifying the vehicle owner provides yet another way of communicating that an object 210 was left in the vehicle 220. The remote server 270 may further transmit a mobile notification to a mobile device to alert the user and the owner of the object 210 left in the vehicle 220.

In a non-limiting embodiment, the action taken by the telematics control unit 260 includes a route action to alter a route of the vehicle 220. In a non-limiting example, the route action allows the vehicle 220 to be routed to a location to drop off objects 210 left behind in the vehicle 220 or to receive cleaning based on a change in the interior 222, as detailed above. In a non-limiting embodiment, the vehicle 220 is an autonomous vehicle and the route action allows the vehicle 220 to be directed to autonomously proceed to the location. As detailed above, the telematics control unit 260 may interface with an onboard navigation system (not shown) or navigation from the remote server 270 to route the vehicle 220 to the location. In this way, the telematics control unit 260 may be used to improve the routing of the vehicle 220 when a routing action is taken.

In a non-limiting embodiment, the remote server 270 remote server transmits the action instruction based upon a predetermined event. Non-limiting examples of predetermined events include a predetermined time period, a predetermined number of uses, a predetermined number of users, a predetermined occurrence, or a combination thereof. For example, the remote server 270 may instruct the telematics control unit 260 to route the vehicle 220 to a car wash when the vehicle 220 has traversed dirt roads, after it rains, or every week. In this way, the action taken by the telematics control unit 260 may be controlled and modified by the action instruction from the remote server 270.

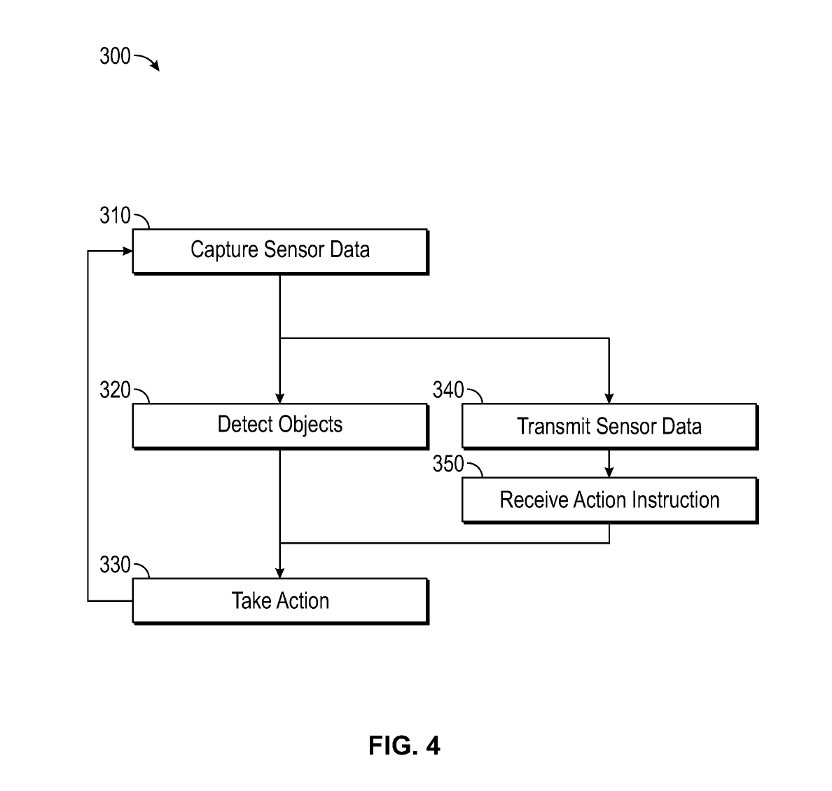

Referring now to FIG. 4, and with continued reference to FIGS. 2 and 3, a flowchart illustrates a method 300 performed by the systems 100, 200 for detecting objects within a vehicle in accordance with the present disclosure. As can be appreciated in light of the disclosure, the order of operation within the method 300 is not limited to the sequential execution as illustrated in FIG. 4, but may be performed in one or more varying orders as applicable and in accordance with the requirements of a given application.

In various exemplary embodiments, the systems 100, 200 and method 300 are run based on predetermined events, and/or can run continuously during operation of the vehicle 120, 220. The method 300 starts at 310 with capturing sensor data of an interior 122, 222 of the vehicle 120, 220 with a sensor 130, 230. At 320, the method 300 detects objects 110, 210 in the interior of the vehicle 120, 220 based on the captured sensor data. At 330, the method 300 takes an action based on the objects 110, 210 detected in the vehicle 120, 220. The method 300 then proceeds to 310 detect additional objects 110, 210 as necessary.

In a non-limiting embodiment, the system 100, 200 further includes a telematics control unit 160, 260 and a remote server 170, 270. In a non-limiting embodiment, after 310, the method 300 proceeds to 340 and the telematics control unit 160, 260 transmits the sensor data to the remote server 170, 270. At 350, the telematics control unit 160, 260 receives an action instruction from the remote server 170, 270. At 360, the method 300 takes the action based on the action instruction then proceeds to 310 to detect addition objects 110, 210 as necessary.

In a non-limiting embodiment, the method 300 adjusts a route of an autonomous vehicle control system based on the action instruction, as detailed above. In a non-limiting embodiment, the method 300 transmits a mobile notification to a mobile device based on the objects 110, 210 detected in the vehicle 120, 220. In a non-limiting embodiment, the sensor 130, 230 includes an optical sensor, an ultrasonic sensor, a laser sensor, a weight sensor or a combination thereof. In a non-limiting embodiment, the action includes a user notification, a horn action, a light action, an owner notification, a route action, or a combination thereof.

While various exemplary embodiments have been presented in the foregoing detailed description, it should be appreciated that a vast number of variations exist. It should also be appreciated that the exemplary embodiments are only examples, and are not intended to limit the scope, applicability, or configuration of the disclosure in any way. Rather, the foregoing detailed description will provide those skilled in the art with a convenient road map for implementing the exemplary embodiments. It should be understood that various changes can be made in the function and arrangement of elements without departing from the scope of the disclosure as set forth in the appended claims and the legal equivalents thereof.

1. A system for detecting objects within a vehicle, the system comprising:
a sensor configured to monitor an interior of the vehicle and generate sensor data;
a detection module configured to detect objects in the interior of the vehicle based on the sensor data; and
an action module configured to take an action based on the objects detected in the interior.

2. The system of claim 1, wherein the sensor is selected from the group consisting of: an optical sensor, an ultrasonic sensor, a laser sensor, a weight sensor, or a combination thereof.

3. The system of claim 1, wherein the action is selected from the group consisting of: a user notification, a horn action, a light action, an owner notification, a route action, or a combination thereof.

4. The system of claim 1, further comprising a telematics control unit configured to report the objects detected to a remote server.

5. The system of claim 4, wherein the telematics control unit is configured to adjust a route of the vehicle based on the action.

6. The system of claim 1, wherein the detection module is configured to detect a change in the interior based on comparison between a steady state interior of the vehicle and a present state interior of the vehicle, and the action module is configured to take the action based on the change in the interior.

7. A system for detecting objects within a vehicle, the system comprising:
a remote server;
a sensor configured to monitor an interior of the vehicle and generate sensor data; and
a telematics control unit configured to transmit the sensor data to the remote server and take an action,
wherein the remote server identifies objects in the interior of the vehicle based on the sensor data and transmits an action instruction to the telematics control unit based on the objects identified in the interior.

8. The system of claim 7, wherein the sensor is selected from the group consisting of: an optical sensor, an ultrasonic sensor, a laser sensor, or a combination thereof.

9. The system of claim 7, wherein the action is selected from the group consisting of: a user notification, a horn action, a light action, an owner notification, a route action, or a combination thereof.

10. The system of claim 7, wherein the telematics control unit is configured to adjust a route of the vehicle based on the action instruction.

11. The system of claim 7, wherein the remote server transmits a mobile notification to a mobile device based on the objects identified in the interior.

12. The system of claim 7, wherein the remote server identifies a change in the interior based on comparison between a steady state interior of the vehicle and a present state interior of the vehicle.

13. The system of claim 7, wherein the remote server transmits the action instruction based upon a predetermined event selected from the group consisting of: a predetermined time period, a predetermined number of uses, a predetermined number of users, a predetermined occurrence, or a combination thereof.

14. The system of claim 7, wherein the telematics control unit is configured to adjust a route of an autonomous vehicle control system based on the action instruction.

15. A method for detecting objects in a vehicle, the method comprising:
capturing sensor data of an interior of the vehicle with a sensor;
detecting objects in the interior of the vehicle based on the captured sensor data; and
taking an action based on the objects detected in the vehicle.

16. The method of claim 15, further comprising:
transmitting the captured sensor data to a remote server with a telematics control unit;
receiving an action instruction from the remote server; and
taking the action based on the action instruction.

17. The method of claim 16, wherein the action taken includes adjusting a route of an autonomous vehicle control system based on the action instruction.

18. The method of claim 15, further comprising transmitting a mobile notification to a mobile device based on the objects detected in the vehicle.

19. The method of claim 15, wherein the sensor is selected from the group consisting of: an optical sensor, an ultrasonic sensor, a laser sensor, a weight sensor or a combination thereof.

20. The method of claim 15, wherein the action is selected from the group consisting of: a user notification, a horn action, a light action, an owner notification, a route action, or a combination thereof.
